(19) United States
(12) Patent Application Publication
(10) Pub. No.: US 2016/0107926 A1
(43) Pub. Date: Apr. 21, 2016

(54) MANUFACTURING METHOD OF FLEXIBLE SUBSTRATE

(71) Applicant: SHENZHEN CHINA STAR OPTOELECTRONICS TECHNOLOGY CO., LTD, Shenzhen (CN)

(72) Inventor: Jiangbo Yao, Shenzhen (CN)

(73) Assignee: SHENZHEN CHINA STAR OPTELECTRONICS TECHNOLOGY CO., LTD, Shenzhen (CN)

(21) Appl. No.: 14/404,634

(22) PCT Filed: Oct. 23, 2014
(86) PCT No.: PCT/CN2014/089237

§ 371 Date: Dec. 1, 2014

(30) Foreign Application Priority Data
Oct. 20, 2014 (CN) 201410559107.X

(51) Int. Cl. C03C 17/00

(52) U.S. Cl. CPC C03C 17/001

(57) ABSTRACT

A manufacturing method of a flexible substrate is provided. The method comprises: coating a flexible substrate material and drying it; using a mask to expose the dried flexible substrate material, wherein the mask has a plurality of opaque regions distanced from each other, and the opaque regions form a designed pattern; developing the flexible substrate material to remove a portion of the flexible substrate material except the opaque regions; and curing the flexible substrate material to form a plurality of films comprising the flexible substrate material, which correspond to the designed pattern.

### FIELD OF THE INVENTION

The present invention relates to a technological field of liquid crystal displays, and more particularly to a manufacturing method of a flexible substrate.

### BACKGROUND OF THE INVENTION

A process of manufacturing a flexible substrate is to coat a flexible substrate material, such as PI (Polyimide), on a glass substrate, which is heated to form a flexible substrate thereafter, and then a thin film transistor process is next to be implemented thereon. However, since the thermal expansion coefficients of the flexible substrate material and the glass substrate are different, the periphery of the glass substrate is warped when the flexible substrate material is shrunk by heating. For solving the above-mentioned problem, there are usually two manners to solve it: one way is to design a particular equipment for the thin film transistor process by attaching a fixture tool and pressure machine, it can ensure that the substrate which is put on a platform is completely flat; another way is to design a particular high viscosity coating device which can control the coating area by hand when processing a PI coating operation, so that the PI can be divided into a plurality of small blocks and respectively coated on the substrate. However, the above-mentioned executing manners both have high processing costs and complex manufacturing technologies.

Hence, it is necessary to provide a manufacturing method of a flexible substrate which solves the problems existing in the conventional technologies.

### SUMMARY OF THE INVENTION

One of the objects of the present invention is to provide a manufacturing method of a flexible substrate, so that a technical problem of the glass substrate being warped in the manufacturing process is solved, the manufacturing process is simplified, and the manufacturing cost is lower.

For solving the above-mentioned technological problems, the present invention constructs a manufacturing method of a flexible substrate, which comprises:

coating a flexible substrate material comprising a photo-sensitive material onto a surface of a glass substrate;

vacuum-drying the flexible substrate material;

using a mask to expose the dried flexible substrate material, wherein the mask has a plurality of opaque regions which are distanced from each other, and the opaque regions form a designed pattern;

developing the exposed flexible substrate material, so as to remove a portion of the flexible substrate material except the opaque regions; and

curing the developed flexible substrate material, so as to form a plurality of films comprising the flexible substrate material, and the films correspond to the designed pattern;

wherein a distance between each two of the adjacent opaque regions is from 0.5-50 millimeters; the flexible substrate material is Polyimide; the developed Polyimide is cured to form the plurality of films of Polyimide corresponding to the designed pattern; and a thickness of the films of Polyimide is in a range of 10-500 micrometers.

In the manufacturing method of the flexible substrate according to the present invention, a distance between each two of the adjacent opaque regions is from 10-40 millimeters.

In the manufacturing method of the flexible substrate according to the present invention, an area of the opaque regions is from 44-27722 square centimeters.

In the manufacturing method of the flexible substrate according to the present invention, a viscosity of the Polyimide is from 2000-20000 centipoises.

In the manufacturing method of the flexible substrate according to the present invention, a thickness of the glass substrate is from 0.4-2 millimeters.

In the manufacturing method of the flexible substrate according to the present invention, a laser is adopted to expose the flexible substrate material, and the laser energy is from 50-100 millijoules per square centimeters.

In the manufacturing method of the flexible substrate according to the present invention, the exposing time is from 40-100 seconds.

In the manufacturing method of the flexible substrate according to the present invention, the curing time is from 10-60 minutes.

The present invention constructs a manufacturing method of a flexible substrate, which comprises:

coating a flexible substrate material comprising a photo-sensitive material onto a surface of a glass substrate;

vacuum-drying the flexible substrate material;

using a mask to expose the dried flexible substrate material, wherein the mask has a plurality of opaque regions which are distanced from each other, and the opaque regions form a designed pattern;

developing the exposed flexible substrate material, so as to remove a portion of the flexible substrate material except the opaque regions; and

curing the developed flexible substrate material, so as to form a plurality of films comprising the flexible substrate material, and the films correspond to the designed pattern.

In the manufacturing method of the flexible substrate according to the present invention, a distance between each two of the adjacent opaque regions is from 0.5-50 millimeters.

In the manufacturing method of the flexible substrate according to the present invention, a distance between each two of the adjacent opaque regions is from 10-40 millimeters.

In the manufacturing method of the flexible substrate according to the present invention, an area of the opaque regions is from 44-27722 square centimeters.

In the manufacturing method of the flexible substrate according to the present invention, the flexible substrate material is Polyimide; the developed Polyimide is cured to form the plurality of films of Polyimide corresponding to the designed pattern; and a thickness of the films of Polyimide is in a range of 10-500 micrometers.

In the manufacturing method of the flexible substrate according to the present invention, a viscosity of the Polyimide is from 2000-20000 centipoises.

In the manufacturing method of the flexible substrate according to the present invention, a thickness of the glass substrate is from 0.4-2 millimeters.

In the manufacturing method of the flexible substrate according to the present invention, a laser is adopted to expose the flexible substrate material, and the laser energy is from 50-100 millijoules per square centimeters.

In the manufacturing method of the flexible substrate according to the present invention, the exposing time is from 40-100 seconds.

In the manufacturing method of the flexible substrate according to the present invention, the curing time is from 10-60 minutes.

In the manufacturing method of the flexible substrate according to the present invention, by exposing and developing the dried flexible substrate material, the films comprising the flexible substrate material can be obtained after a curing operation, so as to decrease a tension by shrinking the film comprising the flexible substrate material, so that a technical problem of the glass substrate being warped in the manufacturing process is avoided, the manufacturing process is simplified, and the manufacturing cost is lower.

### DESCRIPTION OF THE DRAWINGS

FIG. 1 is a flow chart of a manufacturing method of a flexible substrate according to a conventional technology;

FIG. 2 is a flow chart of a manufacturing method of a flexible substrate according to a first embodiment of the present invention; and

FIG. 3 is a structural schematic view of a section of a mask according to the present invention.

### DETAILED DESCRIPTION OF THE PREFERRED EMBODIMENTS

The foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inner, outer, side, and etc., are only directions with reference to the accompanying drawings, so that the used directional terms are used to describe and understand the present invention, but the present invention is not limited thereto. In the drawings, units with similar structures use the same numerals.

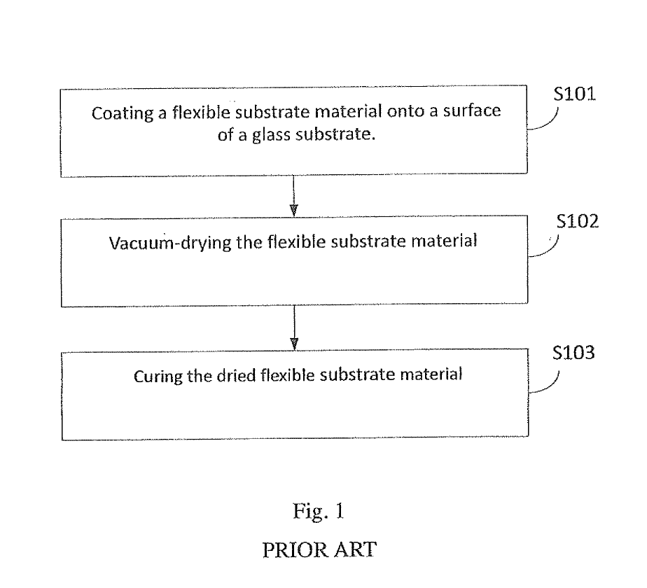

Refer now to FIG. 1, which is a flow chart of a manufacturing method of a flexible substrate according to a conventional technology.

As shown in FIG. 1, the entire flexible substrate is processed on a flat and rigid base platform, and then electronic components are manufactured on the flexible substrate. The manufacturing method of the flexible substrate of the conventional technology comprises steps as follows:

S101: coating a flexible substrate material onto a surface of a glass substrate.

Firstly, the glass substrate is put onto a substrate platform; the glass substrate is cleaned; and the flexible substrate material is coated onto the cleaned surface of the glass substrate.

S102: vacuum-drying the flexible substrate material.

The coated flexible substrate material in step S101 is put into a vacuum environment to be dried, and the purpose of the vacuum-drying is to remove water molecules from the flexible substrate material. During in the drying process, the vacuum environment can prevent impurities from entering.

S103: curing the dried flexible substrate material.

After a high temperature curing of the flexible substrate material, an entire film comprising the flexible substrate material is formed on the glass substrate.

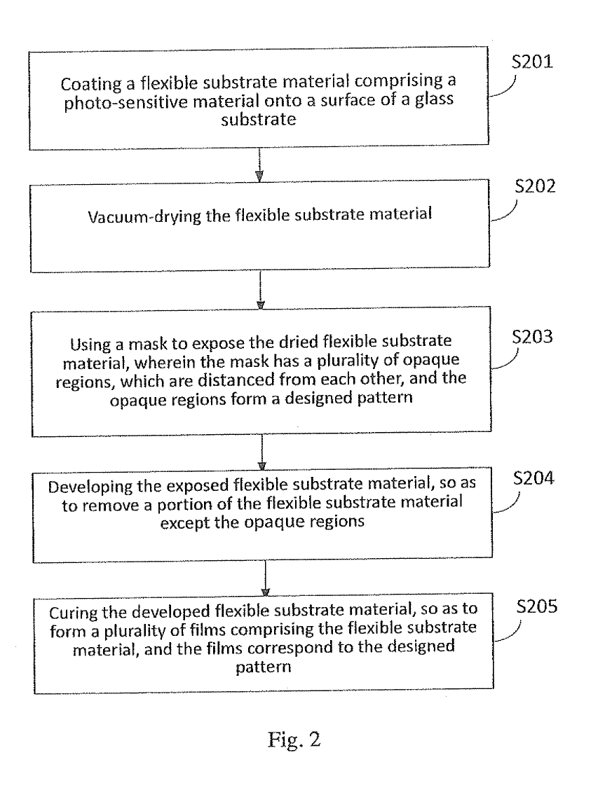

Refer now to FIG. 2, which is a flow chart of a manufacturing method of a flexible substrate according to a first embodiment of the present invention.

As shown in FIG. 2, the entire flexible substrate is processed on a flat and rigid base platform, and then electronic components are manufactured on the flexible substrate. The manufacturing method of the flexible substrate according to a first embodiment of the present invention comprises steps as follows:

S201: coating a flexible substrate material comprising a photo-sensitive material onto a surface of a glass substrate.

Firstly, the glass substrate is put on a substrate platform; the glass substrate is cleaned; and the flexible substrate material is coated onto the cleaned surface of the glass substrate.

The cleaning manner is an ultrasonic cleaning. The flexible substrate material can be Polyimide, silicon rubber, Parylene, silicone resin, etc. The photo-sensitive material can be a sensitizer. The flexible substrate material comprising the photo-sensitive material is a photoresist, which is a positive resist material. A spin coating method or a slit coating method can be adopted to coat the flexible substrate material onto the surface of a glass substrate.

S202: vacuum-drying the flexible substrate material.

The coated flexible substrate material in step S201 is put into a vacuum environment to be dried, and the purpose of the vacuum-drying is to remove water molecules from the flexible substrate material. During the drying process, the vacuum environment can prevent impurities from entering, and increase an adhesion property between the flexible substrate material and the glass substrate. The vacuum-drying step is executed in a vacuum machine.

S203: using a mask to expose the dried flexible substrate material, wherein the mask has a plurality of opaque regions which are distanced from each other, and the opaque regions form a designed pattern.

The mask is further provided with a penetration region. By an exposure operation, the flexible substrate material which corresponds to the penetration region can be illuminated; but the flexible substrate material which corresponds to the opaque region cannot be illuminated. By the penetration region of the mask, light rays can illuminate the glass substrate coated with the positive resist material, and finally the designed pattern formed by the opaque regions of the mask is transferred onto the glass substrate, wherein the opaque regions is arranged as an array distributed on the mask.

S204: developing the exposed flexible substrate material, so as to remove a portion of the flexible substrate material except the opaque regions.

Because the flexible substrate material which corresponds to the penetration region is illuminated, it easily reacts with a developing solution when in the developing process of step S204; and because the flexible substrate material which corresponds to the opaque region is not illuminated, it does not easily react with the developing solution when in the developing process of step S204. After the complete exposing and developing, a portion of the flexible substrate material which corresponds to the designed pattern is reserved, and the others are removed by the developing process.

S205: curing the developed flexible substrate material, so as to form a plurality of films comprising the flexible substrate material, and the films correspond to the designed pattern.

Since in the step S204 the flexible substrate material corresponding to the designed pattern is reserved, the films comprising the flexible substrate material are formed after a heating operation. Moreover, since the opaque regions are arranged as an array, the films comprising the flexible substrate material which is obtained by the step S205 are also arranged as an array. If the flexible substrate material is Polyimide, the developed Polyimide is cured to form a plurality of films of Polyimide which corresponds to the designed pattern.

In the manufacturing method of the flexible substrate according to the present invention, by exposing and developing the dried flexible substrate material, the films comprising the flexible substrate material can be obtained after a curing operation, so as to decrease a tension by shrinking the film comprising the flexible substrate material, so that a technical problem of the glass substrate being warped in the manufacturing process is avoided, the manufacturing process is simplified, and the manufacturing cost is lower.

A manufacturing method of the flexible substrate according to a second embodiment of the present invention comprises steps as follows:

As shown in FIG. 2, the entire flexible substrate is processed on a flat and rigid base platform, and then electronic components are manufactured on the flexible substrate. A flow chat of the manufacturing method of the flexible substrate according to a first embodiment of the present invention comprises steps as follows:

S201: coating a flexible substrate material comprising a photo-sensitive material onto a surface of a glass substrate.

Firstly, the glass substrate of a thickness of 0.4-2 mm is put on a substrate platform; and to clean the glass substrate; and to coat the flexible substrate material onto the cleaned surface of the glass substrate. The cleaning manner is an ultrasonic cleaning. If the glass substrate is too thin, it is easy warped; if the glass substrate is too thick, the following process is influenced and the manufacturing cost is increased. Additionally, the thickness of the glass substrate is preferably 0.5 mm or 0.7 mm.

The flexible substrate material can be Polyimide, silicon rubber, Parylene, silicone resin, etc. The photo-sensitive material can be a sensitizer.

The flexible substrate material comprising the photo-sensitive material is a photoresist, which is a positive resist material. A spin coating method or a slit coating method can be adopted to coat the flexible substrate material onto the surface of a glass substrate.

If the flexible substrate material is a Polyimide, the viscosity of the Polyimide is preferably from 2000-20000 centipoises, so as to form a film of Polyimide with a thickness from 10-500 micrometers. If the viscosity is too small, the above-mentioned range of the thickness cannot be ensured.

S202: vacuum-drying the flexible substrate material.

The coated flexible substrate material in step S201 is put into a vacuum environment to be dried, and the purpose of the vacuum-drying is to remove water molecules in the flexible substrate material. When in the drying process, the vacuum environment can prevent impurities from entering, and increase an adhesion property between the flexible substrate material and the glass substrate. The vacuum-drying step is executed in a vacuum machine. The pressure of the vacuum machine is from 20-100 Pa; the temperature of the platform is from 90-110 degrees; and the time of the vacuum-drying step is preferably from 90-120 seconds. If the pressure is too small, the cleaning is incomplete; if the pressure is too large, the flexible substrate material is easily damaged. If the temperature is too low, the organic solvents are not easily evaporated; if the temperature is too high, the characteristic of the flexible substrate material (specifically being a Polyimide with a viscosity of 2000-20000 centipoises) is easily varied.

S203: using a mask to expose the dried flexible substrate material, wherein the mask has a plurality of opaque regions, which are distanced from each other, and the opaque regions form a designed pattern.

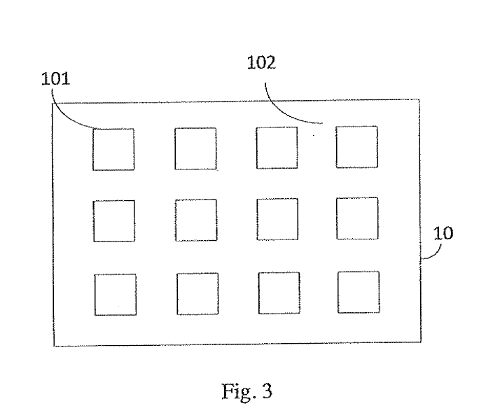

Refer now to FIG. 3, which is a structural schematic view of a section of a mask according to the present invention. The mask 10 is further provided with a penetration region 102 (the portion of the mask 10 except 101), and a plurality of opaque regions 101. By an exposure operation, the flexible substrate material which corresponds to the penetration region 102 can be illuminated; but the flexible substrate material which corresponds to the opaque region 101 cannot be illuminated. Through the penetration region 102 of the mask 10, light rays can illuminate the glass substrate coated with the positive resist material, and finally the designed pattern formed by the opaque regions 101 of the mask 10 is transferred onto the glass substrate, wherein the opaque regions 101 is arranged as an array distributed on the mask 10. The distance between each two adjacent mask 10 is from 0.5-50 millimeters, preferably is from 10-40 millimeters, and the best is 25 millimeters. The area of the opaque regions is from 44-27722 square centimeters, preferably is from 5000-25000 square centimeters, and the best is 15000 square centimeters. When the sharp of the opaque region is a rectangle or a square, the length or width thereof is from 2-50 inches, preferably is from 15-40 inches, and the best is 30 inches. As mentioned above, the chance of the glass substrate being warped is decreases sharply.

In the above-mentioned exposing process, a laser is adopted to expose the flexible substrate material, wherein the wavelength of the laser is from 172-365 nanometers, and preferably is 365 nanometers. The laser energy is more than 50 millijoules per square centimeters. If the laser energy is too small, the designed pattern on the mask cannot be clearly transferred to the glass substrate. Preferably, the laser energy is from 50-100 millijoules per square centimeters. The exposing time is from 40-100 seconds. If the exposing time is too short, the required exposing energy cannot be met.

S204: developing the exposed flexible substrate material, so as to remove a portion of the flexible substrate material except the opaque regions.

Because the flexible substrate material which corresponds to the penetration region 102 is illuminated, it easily reacts with a developing solution when in the developing process of step S204; and because the flexible substrate material which corresponds to the opaque region 101 is not illuminated, it does not easily react with the developing solution when in the developing process of step S204. After the complete exposing and developing, a portion of the flexible substrate material which corresponds to the designed pattern is reserved, and the others are removed by the developing process.

The developing mold can be a soak developing mold, namely to develop the exposed flexible substrate material by a developing solution, wherein the developing solution can be potassium hydroxide, which comprises 238% of Tetramethylammonium hydroxide. The temperature of the developing solution is preferably 23 degrees, and the developing time is preferably from 90-120 seconds.

S205: curing the developed flexible substrate material, so as to form a plurality of films comprising the flexible substrate material, and the films correspond to the designed pattern.

Since in the step S204 the flexible substrate material corresponding to the designed pattern is reserved, the films comprising the flexible substrate material is formed after a heating operation. Moreover, since the opaque regions 101 are arranged as an array, the films comprising the flexible substrate material which is obtained by the step S205 are also arranged as an array. If the flexible substrate material is Polyimide, the developed Polyimide is cured to form a plurality of films of Polyimide which is corresponding to the designed pattern. The thickness range of the film of Polyimide is from 10-500 micrometers, and preferably is 300 micrometers. If the thickness of the film of Polyimide is too thin, it cannot meet a request of manufacturing elements thereon; if the thickness of the Polyimide is too thick, the penetrating property is decreased. The curing temperature is from 110-250 degrees centigrade. If the curing time is more than 10 minutes, the curing time is too short, and the flexible substrate material cannot be completely solidified. Preferably, the curing time is from 10-60 minutes, and the best is 30 minutes. If the curing temperature is to low, the flexible substrate material cannot be completely solidified; if the temperature is too high, the characteristic of the flexible substrate material is easily varied.

Compared with an entire film comprising the flexible substrate material in the conventional technologies, the present invention uses a plurality of blocks of the films comprising the flexible substrate material, and the area of each of the films comprising the flexible substrate material is less than the area of the entire film comprising the flexible substrate material, the tension produced by the each of the film comprising the flexible substrate material is less than the tension produced by the entire film comprising the flexible substrate material. Moreover, since the films comprising the flexible substrate material are distanced from each other, the tension produced by each of the films comprising the flexible substrate material cannot form a resulting force, so as to prevent the glass substrate from a warping phenomenon.

In the manufacturing method of the flexible substrate according to the present invention, by exposing and developing the dried flexible substrate material, the films comprising the flexible substrate material can be obtained after a curing operation, so as to decrease a tension by shrinking the film comprising the flexible substrate material, so that a technical problem of the glass substrate being warped in the manufacturing process is avoided, the manufacturing process is simplified, and the manufacturing cost is lower.

As described above, the present invention has been described with a preferred embodiment thereof and it is understood that many changes and modifications to the described embodiment can be carried out without departing from the scope and the spirit of the invention that is intended to be limited only by the appended claims.

1. A manufacturing method of a flexible substrate, comprising:
coating a flexible substrate material comprising a photo-sensitive material onto a surface of a glass substrate;
vacuum-drying the flexible substrate material;
using a mask to expose the dried flexible substrate material, wherein the mask has a plurality of opaque regions which are distanced from each other, and the opaque regions form a designed pattern;
developing the exposed flexible substrate material, so as to remove a portion of the flexible substrate material except the opaque regions; and
curing the developed flexible substrate material, so as to form a plurality of films comprising the flexible substrate material, and the films correspond to the designed pattern;
wherein a distance between each two of the adjacent opaque regions is from 0.5-50 millimeters; the flexible substrate material is Polyimide; the developed Polyimide is cured to form the plurality of films of Polyimide corresponding to the designed pattern; and a thickness of the films of Polyimide is in a range of 10-500 micrometers.

2. The manufacturing method of the flexible substrate according to claim 1, wherein a distance between each two of the adjacent opaque regions is from 10-40 millimeters.

3. The manufacturing method of the flexible substrate according to claim 1, wherein an area of the opaque regions is from 44-27722 square centimeters.

4. The manufacturing method of the flexible substrate according to claim 1, wherein a viscosity of the Polyimide is from 2000-20000 centipoises.

5. The manufacturing method of the flexible substrate according to claim 1, wherein a thickness of the glass substrate is from 0.4-2 millimeters.

6. The manufacturing method of the flexible substrate according to claim 1, wherein a laser is adopted to expose the flexible substrate material, and the laser energy is from 50-100 millijoules per square centimeters.

7. The manufacturing method of the flexible substrate according to claim 1, wherein the exposing time is from 40-100 seconds.

8. The manufacturing method of the flexible substrate according to claim 1, wherein the curing time is from 10-60 minutes.

9. A manufacturing method of a flexible substrate, comprising:
coating a flexible substrate material comprising a photo-sensitive material onto a surface of a glass substrate;
vacuum-drying the flexible substrate material;
using a mask to expose the dried flexible substrate material, wherein the mask has a plurality of opaque regions which are distanced from each other, and the opaque regions form a designed pattern;
developing the exposed flexible substrate material, so as to remove a portion of the flexible substrate material except the opaque regions; and
curing the developed flexible substrate material, so as to form a plurality of films comprising the flexible substrate material, and the films correspond to the designed pattern.

10. The manufacturing method of the flexible substrate according to claim 9, wherein a distance between each two of the adjacent opaque regions is from 0.5-50 millimeters.

11. The manufacturing method of the flexible substrate according to claim 10, wherein a distance between each two of the adjacent opaque regions is from 10-40 millimeters.

12. The manufacturing method of the flexible substrate according to claim 9, wherein an area of the opaque regions is from 44-27722 square centimeters.

13. The manufacturing method of the flexible substrate according to claim 9, wherein the flexible substrate material is Polyimide; the developed Polyimide is cured to form the plurality of films of Polyimide corresponding to the designed pattern; and a thickness of the films of Polyimide is in a range of 10-500 micrometers.

14. The manufacturing method of the flexible substrate according to claim 13, wherein a viscosity of the Polyimide is from 2000-20000 centipoises.

15. The manufacturing method of the flexible substrate according to claim 9, wherein a thickness of the glass substrate is from 0.4-2 millimeters.

16. The manufacturing method of the flexible substrate according to claim 9, wherein a laser is adopted to expose the flexible substrate material, and the laser energy is from 50-100 millijoules per square centimeters.

17. The manufacturing method of the flexible substrate according to claim 9, wherein the exposing time is from 40-100 seconds.

18. The manufacturing method of the flexible substrate according to claim 9, wherein the curing time is from 10-60 minutes.
